(19) United States
(12) Patent Application Publication
(10) Pub. No.: US 2023/0256540 A1
(43) Pub. Date: Aug. 17, 2023

(54) METHOD FOR LASER WELDING TWO THIN WORKPIECES IN A REGION OF OVERLAP

(71) Applicant: TRUMPF Laser- und Systemtechnik GmbH, Ditzingen (DE)

(72) Inventors: Oliver Bocksrocker, Sachsenheim (DE); Tim Hesse, Ditzingen (DE)

(21) Appl. No.: 18/302,008

(22) Filed: Apr. 18, 2023

Related U.S. Application Data
(63) Continuation of application No. PCT/EP2021/077776, filed on Oct. 7, 2021.

(30) Foreign Application Priority Data
Oct. 29, 2020 (DE) 10 2020 128 464.0

(51) Int. Cl. B23K 26/244; B23K 26/082

(52) U.S. Cl. CPC B23K 26/244; B23K 26/082; B23K 2103/04

(57) ABSTRACT

A method for laser welding two workpieces includes arranging a first workpiece of a thickness D1 and a second workpiece of a thickness D2 on top of one another so that the first workpiece and the second workpiece overlap in a region of overlap. Each of D1 and D2 is 400 μm or less. The method further includes melting, using a laser beam guided along a weld seam, a material of the first workpiece over an entirety of the thickness D1 and a material of the second workpiece over only a partial thickness TD of the thickness D2 in the region of overlap, from a side of the first workpiece. The laser beam generates a vapor capillary that extends to a capillary depth KT into the first workpiece or into the first workpiece and the second workpiece, where 0.33*EST≤KT≤0.67*EST, with EST being a weld depth EST=D1+TD.

### CROSS REFERENCE TO RELATED APPLICATIONS

This application is a continuation of International Application No. PCT/EP2021/077776 (WO 2022/089912 A1), filed on Oct. 7, 2021, and claims benefit to German Patent Application No. DE 10 2020 128 464.0, filed on Oct. 29, 2020. The aforementioned applications are hereby incorporated by reference herein.

### FIELD

Embodiments of the present invention relate to a method for laser welding two workpieces along a weld seam.

### BACKGROUND

Laser welding (also called laser beam welding) is used to permanently connect meltable, usually metallic workpieces to one another. In this case, the laser welding can be effected with relatively high speed, high precision (in particular with a narrow weld seam) and low thermal distortion of the workpieces.

Depending on the beam intensity of the laser beam used, the laser welding may be effected as heat conduction welding or as deep penetration welding.

In deep penetration welding, the laser beam generates a pronounced vapor capillary (keyhole) in the workpiece material, said vapor capillary extending along the beam direction into the workpiece material. As a result of multiple reflections of the laser beam at the walls of the vapor capillary, the absorption in the workpiece material is increased. The material can also be melted in the depth and in a large volume. The deep penetration welding can be effected with a relatively high feed rate (welding speed). However, spatter and the formation of pores often occurs during deep penetration welding, and an irregular weld depth along the weld seam is frequently also observed (spiking). When welding thin workpieces, local connection problems may then occur; the weld seam may be mechanically unstable, or a desired gas-tightness or a desired quality of an electrical contact-connection is not achieved.

In heat conduction welding, the workpiece material is melted by the laser beam close to the surface, without producing a noticeable vapor capillary. The weld depth is essentially determined by the heat conduction of the workpiece material. Irregularities such as spatter or pores rarely occur, and the weld seam is relatively smooth. However, a disadvantage is a relatively low feed rate and weld depth; increased thermal distortion may also occur.

### SUMMARY

A method for laser welding two workpieces along a weld seam includes arranging a first workpiece and a second workpiece on top of one another so that the first workpiece and the second workpiece overlap at least in a region of overlap. The first workpiece has a thickness D1, and the second workpiece has a thickness D2. Each of D1 and D2 is 400 μm or less. The method further includes melting, using a laser beam guided along the weld seam, a material of the first workpiece over an entirety of the thickness D1 and a material of the second workpiece over only a partial thickness TD of the thickness D2 in the region of overlap, from a side of the first workpiece. The laser beam generates a vapor capillary that extends to a capillary depth KT into the first workpiece or into the first workpiece and the second workpiece, where 0.33*EST≤KT≤0.67*EST, with EST being a weld depth EST=D1+TD.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1a shows a schematic cross section through two workpieces, which are welded by the method according to embodiments of the invention, perpendicularly with respect to the feed direction of the laser beam and at the height of the vapor capillary;

FIG. 1b shows a schematic oblique view of the workpieces of FIG. 1a;

FIG. 2a shows a schematic cross section through two workpieces, which are welded by heat conduction welding in a manner which deviates from embodiments of the invention;

FIG. 2b shows a schematic cross section through two workpieces, which are welded according to embodiments of the invention in the transition mode of heat conduction welding and deep penetration welding;

FIG. 2c shows a schematic cross section through two workpieces, which are welded by deep penetration welding in a manner which deviates from embodiments of the invention;

FIG. 3a shows a schematic cross section through two convexly curved workpieces, which are intended to be welded according to embodiments of the invention;

FIG. 3b shows a schematic cross section through the workpieces of FIG. 3a, which are welded according to embodiments of the invention in the pressed-together, elastically deformed state.

### DETAILED DESCRIPTION

Embodiments of the invention can achieve a high seam quality with a high feed rate during the welding of thin workpieces.

Embodiments of the invention provide a method for laser welding two workpieces along a weld seam,
a first workpiece having a thickness D1 and a second workpiece having a thickness D2 being arranged on top of one another so as to overlap at least in a region of overlap,
the thicknesses D1, D2 of the two workpieces each being 400 μm or less,
the material of the first workpiece being melted over the total thickness D1 thereof and the material of the second workpiece being melted over only a partial thickness TD of the total thickness D2 thereof in the region of overlap, from the side of the first workpiece, by means of a laser beam which is guided along the weld seam,
and the laser welding being carried out in such a way that the laser beam generates a vapor capillary which extends to a capillary depth KT into the first workpiece or into the first and second workpiece, wherein 0.33*EST≤KT≤0.67*EST, with weld depth EST=D1+TD.

Embodiments of the present invention conduct the laser welding of two thin workpieces in the lap joint in a transition mode between heat conduction welding and deep penetration welding (“transition mode welding”). This makes it possible to largely utilize the advantages of both processes and to largely avoid the disadvantages of both processes. In particular, a sufficient weld depth can be observed with a high degree of accuracy, such that in particular also gastight connections exhibiting good electrical conductivity can be established in a reliable manner. At the same time, manufacturing can be performed with a relatively high feed rate.

Under the conditions according to embodiments of the invention for the capillary depth KT (extent of the vapor capillary into the workpiece material) in relation to the weld depth EST (extent of the melt bath into the workpiece material), the welding is effected in the desired transition range between heat conduction welding and deep penetration welding, and a high weld seam quality can be achieved with a relatively high feed rate.

In the context of the method according to embodiments of the invention, a vapor capillary is produced, however the latter is relatively short (in the direction into the workpiece material or in the laser beam direction) compared with conventional deep penetration welding. The weld depth is essentially determined both by heat conduction and by the depth of the vapor capillary, the two proportions being of approximately equal size. This makes it possible to achieve a greater weld depth than in the case of heat conduction welding, which is in particular well suited for the welding of thin workpieces such as metal sheets. At the same time, however, the melt bath dynamics remain low, in particular because the total quantity of the melted material also remains relatively low. The energy absorption from the laser beam into the workpiece material is less pronounced than in the case of deep penetration welding, because the low capillary depth permits only a few reflections of the laser beam within the vapor capillary. In addition, the melting of the workpiece material by heat conduction, which is substantially synchronous with the feed rate, by contrast largely compensates for more rapid dynamic movements in the melt bath.

The weld depth EST can be measured during the welding process for example by means of ultrasonic waves, which are reflected at the interface of liquid workpiece material and solid workpiece material. The capillary depth KT of the vapor capillary can be measured during the welding process for example by means of the reflection of a measurement laser beam at the capillary bottom. Other parameters are usually already known (for instance focus diameter of the laser beam) or are easily ascertained by means of other sensors during the welding process. By way of example, some parameters may be measured optically by means of a camera during the welding process, in particular the width B of the weld seam/of the melted region or the capillary width KB at the workpiece surface transversely with respect to the feed direction, which corresponds approximately to the focus diameter FDQ transversely with respect to the feed direction. Accordingly, the observance of the conditions according to embodiments of the invention can, if desired, be checked and, where appropriate, readjusted during the welding process.

A melted region of a melt width SB is produced around the vapor capillary approximately uniformly in all directions (in the plane transverse to the feed direction). If the focus diameter FDQ of the laser beam at the (front) surface of the first workpiece W1, said surface facing the laser beam, transversely with respect to the welding direction is known, said focus diameter corresponding approximately to the local width of the vapor capillary KB, the width B of the weld seam at the front workpiece surface can be used to readily determine the melt width SB to give SB=(B−FDQ)/2. On the basis of the difference between the weld depth EST, which can be readily seen in section (transverse section), and the thus determined melt width SB, it is then also possible to approximately determine the capillary depth KT in section to give KT=EST−SB. Accordingly, the observance of the conditions according to embodiments of the invention can also easily be checked subsequently on the welded workpiece, and where appropriate process parameters can then be iterated in order to observe the conditions according to embodiments of the invention in the case of future workpieces.

It should be noted that the melt width SB in the context of embodiments of the invention usually corresponds approximately to the capillary depth KT, preferably with 0.67*SB≤KT≤1.33*SB, particularly preferably 0.80*SB≤KT≤1.20*SB.

The thicknesses and depths are determined in each case perpendicularly with respect to that surface of the first workpiece which faces the laser beam (in particular KT, EST, D1, D2). Preferably, in the context of embodiments of the invention, an unstretched laser beam (with an aspect ratio FDQ/FDL of around 1, usually with 0.8≤FDQ/FDL≤1.2, preferably 0.9≤FDQ/FDL≤1.1) is used for the laser welding. The focus of the laser beam on the workpiece surface is typically round (isotropic laser beam).

In a preferred variant of the method according to embodiments of the invention,
0.40*EST≤KT≤0.60*EST,
preferably 0.45*EST≤KT≤0.55*EST. This parameter range has proven particularly successful in practice. The proportions of heat conduction and capillary depth at the weld depth are then particularly well balanced.

Preference is also given to a variant in which
0.25*D2≤TD≤0.75*D2,
preferably 0.33*D2≤TD≤0.67*D2,
particularly preferably 0.40*D2≤TD≤0.60*D2. This makes it possible to achieve a particularly reliable connection of the second workpiece to the first workpiece. On the one hand, a sufficient partial thickness of the second workpiece is melted in order to ensure a mechanical minimum connection. At the same time, an excessively large partial thickness is also not melted, which reduces the risk of through-welding; a through-weld can weaken the connection mechanically on account of material loss. In addition, at greater partial thicknesses, in particular TD>0.5*D2, the mechanical connection is usually not improved any further, but the energy requirement of the welding process and at the same time also the risk of undesirably high melt bath dynamics increases.

Particular preference is given to a variant in which the laser welding is conducted in such a way that for a width KB of the vapor capillary on a surface of the first workpiece, said surface facing the laser beam, measured transversely with respect to a running direction of the weld seam, the following applies:
0.50≤KT/KB≤2.00,
preferably 0.75≤KT/KB≤1.50,
in particular wherein for a focus diameter FDQ of the laser beam transversely with respect to a feed direction of the laser beam and a focus diameter FDL of the laser beam along the feed direction, in each case measured in the plane of that surface of the first workpiece which faces the laser beam, the following applies:
0.8≤FDQ/FDL≤1.2,
preferably 0.9≤FDQ/FDL≤1.1. The desired transition welding and the advantages associated therewith, in particular a uniform weld depth EST and a high possible feed rate, are best achieved at the specified aspect ratios for KT/KB. These aspect ratios for KT/KB are particularly well suited when FDL≥FDQ. In addition, the use of a laser with an unstretched focus profile, for example with an approximate point focus, with an aspect ratio FDQ/FDL around 1 has proven successful, in particular in order to keep the melt bath dynamics low. The following often also applies: 0.50≤EST/B≤1.50, preferably 0.75≤EST/B≤1.25.

Furthermore, preference is given to a variant in which the laser beam has a mean wavelength λ,
where λ≤1200 nm,
preferably
a) 900 nm≤λ≤1100 nm, in particular λ=1030 nm or 1064 nm or 1070 nm, or
b) 500 nm≤λ≤600 nm, in particular λ=515 nm, or
c) 400 nm≤λ≤500 nm, in particular λ=450 nm. These mean laser wavelengths are well suited for the welding of thin workpieces such as steel sheets.

Furthermore, a variant in which the laser beam has a mean laser power P, with
60 W≤P<1200 W,
preferably 100 W≤P<500 W, is advantageous. With these laser powers, the transition mode laser welding according to embodiments of the invention can, in practice, be readily implemented for a number of types of workpiece.

Furthermore, preference is given to a variant in which the laser beam has, in the plane of that surface of the first workpiece which faces the laser beam, a focus diameter FD, with
10 μm≤FD≤100 μm,
preferably 14 μm≤FD≤60 μm,
particularly preferably 25 μm≤FD≤39 μm. These diameters can be readily used in practice for welding thin workpieces in the context of embodiments of the invention in transition mode. Here, the focus diameter FD is assumed to be a maximum focus diameter, wherein generally 0.8≤FDQ/FDL≤1.2, preferably 0.9≤FDQ/FDL≤1.1.

Furthermore, preference is given to a variant in which for a width B of the melted material of the first workpiece on the surface thereof facing the laser beam, measured transversely with respect to a running direction of the weld seam, the following applies:
60 μm≤B≤600 μm,
preferably 80 μm≤B≤400 μm,
particularly preferably 100 μm≤B≤200 μm. In this range, a good mechanical connection can be achieved with the thin workpieces.

Particular preference is given to a variant in which:
D1≤250 μm and D2≤250 μm,
preferably 50 μm≤D1≤200 μm and 50 μm≤D2≤200 μm,
particularly preferably 75 μm≤D1≤100 μm and 75 μm≤D2≤100 μm. With these
workpiece thicknesses, very good weld seam qualities have been achieved in practice at a high welding speed. In many applications, D1=D2 or 0.8*D1≤D2≤1.2*D1, at least in the region of the weld seam.

Preference is also given to a variant in which:
50 μm≤EST≤600 μm,
preferably 60 μm≤EST≤400 μm,
particularly preferably 75 μm≤EST≤225 μm. In the context of embodiments of the invention, these weld depths are very readily realizable, in particular also very constant over the length of the weld seam. In the case of a weld according to embodiments of the invention, the weld depth EST generally fluctuates by less than 20%, usually by less than 10%, and often by less than 5%, from the average value thereof.

A variant in which the laser beam is moved at a feed rate v relative to the workpieces, with
v≥5 m/min,
preferably v≥10 m/min,
is advantageous, in particular the laser beam being deflected by means of a laser scanner. In the context of embodiments of the invention, the specified high feed rates (welding speeds) can generally be established with good weld seam quality without any problems, and permit a high manufacturing efficiency.

Preference is also given to a variant in which the two workpieces are in the form of curved metal sheets which are pressed against one another by way of convexly curved outer sides during the laser welding, such that the metal sheets are oriented in an approximately plane-parallel manner and bear against one another in a contact zone by elastic deformation, the laser beam welding the two metal sheets along the weld seam in the region of this contact zone,
in particular the two curved metal sheets being manufactured from steel. This procedure enables a particular robust connection of the workpieces. The elastic deformation avoids or minimizes a gap (empty space) between the workpieces during the welding process, and the weld is obtained, in spite of the curvature of the workpieces in the relaxed state, over the same width as in the case of planar workpieces.

A variant in which the two workpieces are in the form of flexible metal foils is also advantageous. When welding the flexible metal foils, embodiments of the invention make it possible to generate a very reliable, robust mechanical connection. Typically, the foils are pressed against one another during the welding by means of a ram.

Embodiments of the present invention also include the use of a method as claimed in one of the preceding claims for welding electrical conductors and/or gas seals formed by the two workpieces. Embodiments of the invention can enable a very reliable welded connection of the two workpieces, which satisfies high requirements in terms of gas-tightness (or liquid-tightness), and can ensure low electrical (or thermal) contact resistances between the workpieces. Therefore, the use in electrical conductors and gas seals is particularly advantageous.

In a preferred variant of the use according to embodiments of the invention, the two workpieces are bipolar plates of a fuel cell. The bipolar plates of a fuel cell generally have to both be connected in a gas-tight manner (usually for oxygen) and have a good electrical connection, in order to be able to transport current generated by the fuel cell with little loss. In addition, bipolar plates have thicknesses which can be readily connected by the method according to embodiments of the invention.

Further advantages of the embodiments of the invention are evident from the description and the drawing. Similarly, according to embodiments of the invention, the features mentioned above and those yet to be explained further can be used in each case individually or together in any desired combinations. The embodiments shown and described should not be understood as an exhaustive list, but rather are of an exemplary character for outlining embodiments of the invention.

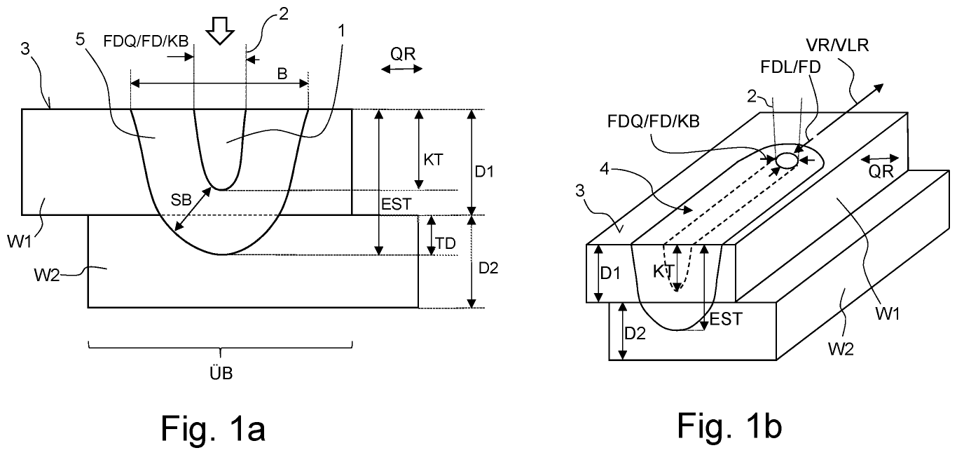

FIG. 1a, in a schematic cross section (perpendicularly with respect to a feed direction VR and in the center of a vapor capillary 1), and FIG. 1b, in a schematic oblique view, illustrate an exemplary variant of the method according to embodiments of the invention for laser welding two thin workpieces W1, W2. The workpieces W1, W2 are illustrated only in a subregion for the purposes of simplification. The workpieces W1, W2 may be in the form, for example, of flexible foils.

The first workpiece W1 and the second workpiece W2 are arranged lying one on top of the other so as to overlap in a region of overlap UB; for this purpose, suitable holding tools may be used (for example robot arms or rams, not illustrated in any more detail). The workpieces W1, W2 have, in the region of overlap UB, the thicknesses D1 and D2, the thicknesses being selected here such that D1=D2=100 μm. The workpieces W1, W2 are usually manufactured from metallic material. The thicknesses D1, D2 are measured perpendicularly with respect to a surface 3 of the first workpiece W1.

A laser beam 2 is directed onto the surface 3 of the first workpiece W1 in order to weld the workpieces W1, W2 to one another in the lap joint. In this case, the laser beam 2 is moved relative to the workpieces W1, W2 along the feed direction VR, typically by means of a laser scanner (not illustrated) which is configured, for example, with a mirror that is movable by means of a piezo drive. The laser beam 2 is generated, for example, by an IR laser with a wavelength of 1030 nm. As a result, the laser beam 2 generates a weld seam 4 with a running direction VLR which corresponds to the feed direction VR.

Here, the laser beam 2 generates the vapor capillary 1 in the material of the first workpiece W1 (it should be noted that the vapor capillary may also reach into the second workpiece in other variants when the second workpiece is considerably thicker than the first workpiece, not illustrated). The vapor capillary 1 has, at the surface 3 of the first workpiece W1, a (maximum) capillary width KB which corresponds very accurately to the (maximum) focus diameter FDQ of the laser beam 2, said focus diameter being measured in a transverse direction QR. The transverse direction QR runs perpendicular to the feed direction VR and in the plane of that surface 3 of the first workpiece W1 which faces the laser beam 2.

Here, the laser beam 2 is in the form of a circular point focus, such that a (maximum) focus diameter FDL (also called focus longitudinal diameter) along the feed direction VR is equal to the focus diameter FDQ (also called focus transverse diameter) in the transverse direction QR. Here, the laser beam 2 has a direction-independent, homogeneous focus diameter FD, which represents a preferred variant.

The vapor capillary 1 in this case reaches to a capillary depth KT into the material of the first workpiece W1. In the variant shown, KT is approximately ¾ of the thickness D1, that is to say about 75 μm.

The material of the workpieces W1, W2 is melted around the vapor capillary 1; a melt bath 5 is thus formed. Proceeding from the vapor capillary 1, the material (in the cross-sectional plane shown in FIG. 1a perpendicular to the feed direction VR) is melted in all directions uniformly over an approximately homogeneous melt width SB. The melt width SB is about 65 μm in this case. Accordingly, the material of the second workpiece W2 is melted over a partial thickness TD of about 40 μm in this case. The weld depth EST=D1+TD, to which the material of the workpieces W1, W2 is melted overall proceeding from the surface 3, is about 140 μm in this case. Here, KT=0.54*EST therefore approximately applies.

In the variant shown, the vapor capillary 1 also has a capillary width KB of approximately 50 μm, which is measured in the transverse direction QR in the plane of the workpiece surface 3. It should be noted that the capillary width KB corresponds very accurately to the focus diameter FDQ in the transverse direction QR. Accordingly, the capillary depth KT is approximately 1.5 times as great as the capillary width KB, that is to say about KB/KT=1.50. The weld seam 4 has a width B (measured in the transverse direction QR) of about 180 μm in this case, corresponding to the sum KB+2*SB. The partial thickness TD over which welding is performed into the second workpiece W2 is in this case approximately 40% of the total thickness D2, that is to say TD=0.40*D2.

In particular, the laser power of the laser beam 2, the focus diameter FD of the laser beam 2 at the workpiece surface 3 and a feed rate (welding speed) of the laser welding have been selected such that the ratios of vapor capillary 1, melt bath 5 and workpiece geometry shown here are set for carrying out the laser welding in the transition mode between heat conduction welding and deep penetration welding.

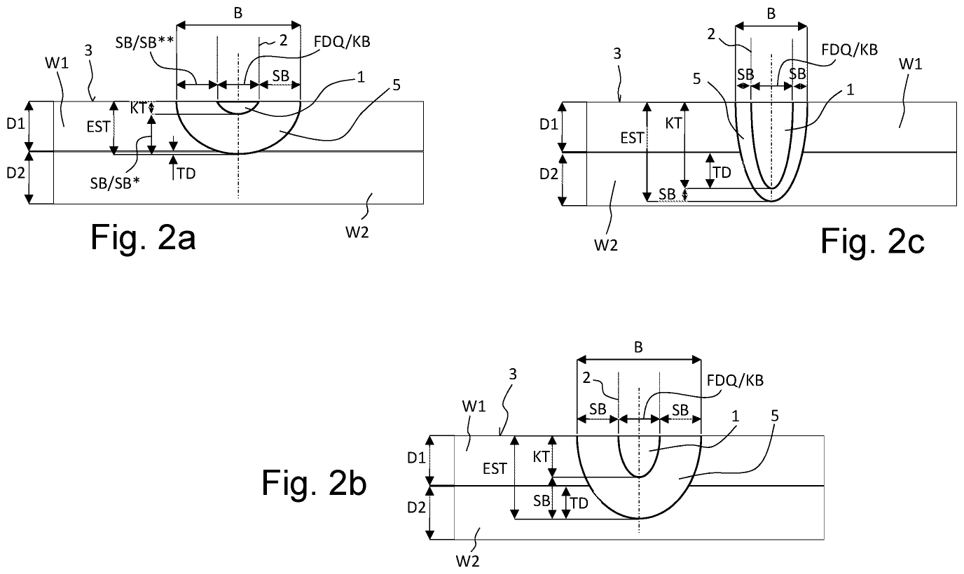

FIGS. 2a, 2b and 2c give an overview of the ratios of capillary depths KT and weld depths EST, and also of capillary widths KB and capillary depths KT, during the laser welding in different welding modes in cross sections perpendicular to the feed direction (similarly to FIG. 1a); in the example shown, an unstretched focus geometry of the laser beam 2 is assumed (with FDQ=FDL, for instance with a circular-round point focus/isotropic laser beam). FIG. 2a illustrates a typical heat conduction welding operation, FIG. 2b illustrates a typical transition mode laser welding operation according to embodiments of the invention, and FIG. 2c illustrates a typical deep penetration laser welding operation.

In the heat conduction welding operation, as illustrated in FIG. 2a, the laser beam 2 generates a shallow vapor capillary 1 which is only very small and which has a low capillary depth KT (or even no noticeable vapor capillary at all, the latter not being illustrated). The weld depth EST generated is based substantially on the width of the melt bath 5 or on the melt width SB, with EST=KT+SB, thus KT is considerably smaller than SB. It should be noted that, in practice, the melt width SB* at the lowest point of the vapor capillary 1 corresponds very accurately to the melt width SB** in the workpiece surface 3, such that in the following text the melt width is uniformly denoted by SB. In the example shown, KT=0.23*EST approximately. In the context of the embodiments of the invention, the range KT<0.33*EST is assigned to the undesired heat conduction mode. The weld depth EST reaches into the second workpiece W2 only to a minimal extent, here such that TD=0.08*D2 approximately.

In addition, in the heat conduction mode (with the isotropic laser beam 2 used), the capillary depth KT is additionally also considerably smaller than the capillary width KB. In FIG. 2a, KT/KB=0.30 approximately. In the context of the embodiments of the invention, the range KT/KB<0.50 is assigned to the undesired heat conduction mode.

FIG. 2b illustrates the transition mode laser welding according to embodiments of the invention. The laser beam 2 generates a medium-sized vapor capillary 1. The weld depth EST is based, to approximately equal parts, on the capillary depth KT of the vapor capillary 1 and on the melt width SB of the melt bath 5. In the example shown, KT=0.5*EST approximately. In the context of the embodiments of the invention, the range 0.33≤KT/EST≤0.67 is assigned to the desired transition mode. The weld depth EST reaches significantly into the second workpiece W2, here such that TD=0.6*D2 approximately.

In the transition mode, the capillary depth KT is additionally also of similar size or only slightly greater than the capillary width KB. In FIG. 2b, KT/KB=1.0 approximately. In the context of the embodiments of the invention (with the isotropic laser beam 2 used, or at least when FDQ≤FDL), the range 0.50≤KT/KB≤2.00 is assigned to the desired transition mode laser welding.

FIG. 2c lastly illustrates the deep penetration laser welding. The laser beam 2 generates a very large, deep vapor capillary 1. The weld depth EST is based substantially on the capillary depth KT of the vapor capillary 1. In the example shown, KT=0.88*EST approximately. In the context of the embodiments of the invention, the range KT>0.67*EST is assigned to the undesired deep penetration welding mode. The weld depth EST in this case reaches through almost the entire second workpiece W2, here such that TD=0.96*D2 approximately (in many cases, the deep penetration welding mode even results in the formation of a through-weld, that is to say TD=D2, the latter not being illustrated).

In the deep penetration welding mode (with the isotropic laser beam 2 used), the capillary depth KT is additionally also considerably greater than the capillary width KB. In FIG. 2c, KT/KB=2.1 approximately. In the context of the embodiments of the invention, the range KT/KB>2.0 is assigned to the undesired deep penetration laser welding.

With a known focus diameter FDQ in the transverse direction QR (or a known capillary width KB), the capillary depth KT can be easily ascertained from the width B of the weld seam and the weld depth EST. B and EST can be easily seen in section (transverse section as in FIGS. 2a-2c) or can also be readily observed in situ with a camera and ultrasound. On the basis of B and FDQ (the latter corresponds to KB), SB can be determined such that
SB=(B−FDQ)/2, and furthermore KT=EST-SB.

In the example of FIGS. 2A-2c, D2 is somewhat greater than D1, but often D1=D2.

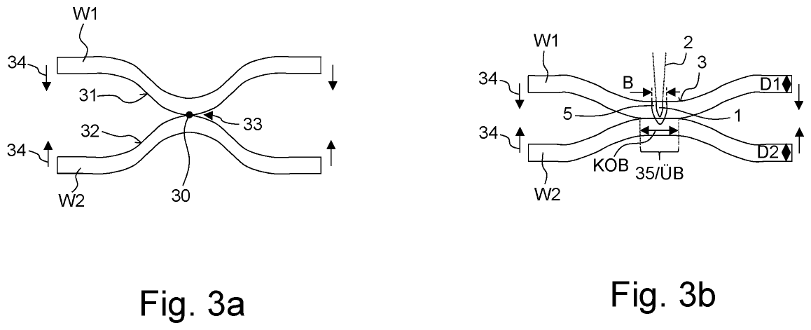

FIG. 3a schematically shows two workpieces W1, W2, which are in the form of curved metal sheets, in particular steel sheets, in a schematic cross section perpendicular to the desired weld seam. In this case, the two workpieces W1, W2 are in the form of bipolar plates for a fuel cell. It should be noted that FIG. 3a (just like FIG. 3b) shows only a subregion of the workpieces W1, W2, in which a weld according to embodiments of the invention is intended to be effected. It should also be noted that the two workpieces W1, W2 may possibly also obtain a plurality of weld seams (not illustrated).

The two workpieces W1, W2 have mutually facing, convexly curved outer sides 31, 32. If the two workpieces (metal sheets) W1, W2 are placed against one another by way of these curved outer sides, contact occurs only along a narrow contact line 30; in the cross section shown in FIG. 3a perpendicular to this contact line 30, this contact line 30 appears as a point.

A weld of the workpieces W1, W2 along this contact line 30 would be very difficult, since the region which would normally be melted in the case of plane-parallel abutment would lie partially in a or a plurality of V-shaped empty spaces 33 between the workpiece outer sides 31, 32; as a result, gaps or at least weak regions could easily be produced in the weld seam.

According to embodiments of the invention, for the welding, the workpieces W1, W2 are pressed toward one another by way of their convex outer sides 31, 32 (cf. pressing direction 34), as a result of which elastic deformation of the outer sides 31, 32 occurs (cf. FIG. 3b). In this case, the convex outer sides 31, 32 are pressed flat slightly, and a contact zone 35 which is extended transversely with respect to the pressing direction and in which the workpieces W1, W2 or the metal sheets are oriented approximately plane-parallel to one another and bear against one another is formed around the former contact line.

In this elastically deformed state of the workpieces W1, W2, the laser welding according to embodiments of the invention is effected by means of a laser beam 2 which is directed onto the workpiece surface 3 of the first workpiece W1. In this case, the feed direction of the laser beam 2 lies perpendicular to the plane of the drawing of FIG. 3b. The laser beam 2 melts the material of the first workpiece W1 over the full thickness D1 thereof and the material of the second workpiece W2 over about half of the thickness D2 thereof (cf. for example FIG. 2b with regard to the conditions of the transition mode according to embodiments of the invention). The melting of the workpiece material takes place within the contact zone 35, which at the same time represents a region of overlap UB of the workpieces W1, W2, in which the workpieces W1, W2 lie on top of one another so as to overlap.

It should be noted that the elastic deformation of the workpieces W1, W2 or the force of the pressing is selected to be of such a pronounced extent that a contact width KOB of the contact zone 35 is greater than the width B of the weld seam 4. This makes it possible to obtain a particularly high-quality weld seam 4, comparable to the quality of a weld of two planar workpieces lying against one another (as shown in FIG. 1a). The weld seam obtainable in FIG. 3b can be manufactured in particular in a gas-tight manner and with a low electrical resistance between the workpieces W1, W2.

After the laser welding and sufficient cooling of the workpieces W1, W2, the pressing force is released again, and the workpieces W1, W2 spring back approximately into the elastically relaxed state shown in FIG. 3a. However, they remain welded to one another with a good seam quality over the width B.

In a preferred variant of the method according to embodiments of the invention, a weld may be effected in particular with the following parameters:
workpiece thicknesses D1=D2=75 μm;
weld depth EST=112.5 μm;
FD=KB=31.5 μm;
KT=47.5 μm;
SB=65.25 μm;
B=162 μm.

In this case, KT/KB=1.5 and KT=0.42*EST and TD=0.5*D2 therefore applies.

In another preferred variant of the method according to embodiments of the invention, a weld may be effected in particular with the following parameters:
workpiece thicknesses D1=D2=75 μm;
weld depth EST=112.5 μm;
FD=KB=31.5 μm;
KT=63 μm;
SB=49.5 μm;
B=130.5 μm.

In this case, KT/KB=2.0 and KT=0.56*EST and TD=0.5*D2 therefore applies.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE DESIGNATIONS

1 Vapor capillary
2 Laser beam
3 Workpiece surface
4 Weld seam
5 Melt bath
30 Contact line
31 Outer side (first workpiece)
32 Outer side (second workpiece)
33 Empty space
34 Pressing direction
35 Contact zone
B Width of the weld seam
D1 Thickness of the first workpiece
D2 Thickness of the second workpiece
EST Weld depth
FD (Maximum) focus diameter
FDL (Greatest) focus diameter in feed direction
FDQ (Greatest) focus diameter in transverse direction
KB Capillary width
KOB Contact width
KT Capillary depth
QR Transverse direction
SB Melt width
SB* Melt width (measured centrally under the vapor capillary)
SB** Melt width (measured at the workpiece surface)
TD Partial thickness
UB Region of overlap
VLR Running direction of the weld seam
VR Feed direction
W1 First workpiece
W2 Second workpiece

1. A method for laser welding two workpieces along a weld seam, the method comprising:
arranging a first workpiece and a second workpiece on top of one another so that the first workpiece and the second workpiece overlap at least in a region of overlap, the first workpiece having a thickness D1 and the second workpiece having a thickness D2, each of D1 and D2 being 400 μm or less, and
melting, using a laser beam guided along the weld seam and from a side of the first workpiece, a material of the first workpiece over an entirety of the thickness D1 and a material of the second workpiece over only a partial thickness TD of the thickness D2 in the region of overlap,
wherein the laser beam generates a vapor capillary that extends to a capillary depth KT into the first workpiece or into the first workpiece and the second workpiece, wherein 0.33*EST≤KT≤0.67*EST, with EST being a weld depth EST=D1+TD.

2. The method as claimed in claim 1, wherein
0.40*EST≤KT≤0.60*EST.

3. The method as claimed in claim 1, wherein
0.25*D2≤TD≤0.75*D2.

4. The method as claimed in claim 1, wherein a width KB of the vapor capillary on a surface of the first workpiece facing the laser beam, measured transversely with respect to a running direction of the weld seam, satisfies:
0.50≤KT/KB≤2.00.

5. The method as claimed in claim 4, wherein a focus diameter FDQ of the laser beam transversely with respect to a feed direction of the laser beam and a focus diameter FDL of the laser beam along the feed direction, measured in a plane of the surface of the first workpiece that faces the laser beam, satisfy:
0.8≤FDQ/FDL≤1.2.

6. The method as claimed in claim 1, wherein the laser beam has a mean wavelength λ,
with 400 nm≤λ≤1200 nm.

7. The method as claimed in claim 1, wherein the laser beam has a mean laser power P, with
60 W≤P≤1200 W.

8. The method as claimed in claim 1, wherein the laser beam has a focus diameter FD, in a plane of a surface of the first workpiece that faces the laser beam, satisfies:
10 μm≤FD≤100 μm.

9. The method as claimed in claim 1, wherein a width B of the melted material of the first workpiece on a surface of the first workpiece that faces the laser beam, measured transversely with respect to a running direction of the weld seam, satisfies:
60 μm≤B≤600 μm.

10. The method as claimed in claim 1, wherein:
D1≤250 μm and D2≤250 μm.

11. The method as claimed in claim 1, wherein:
50 μm≤EST≤600 μm.

12. The method as claimed in claim 1, wherein the laser beam is moved at a feed rate relative to the first workpiece and the second workpiece, with
v≥5 m/min.

13. The method as claimed in claim 12, wherein the laser beam is deflected by a laser scanner.

14. The method as claimed in claim 1, wherein the first workpiece and the second workpiece are in a form of curved metal sheets that are pressed against one another by way of convexly curved outer sides during the laser welding, such that the metal sheets are oriented in an approximately plane-parallel manner and bear against one another in a contact zone by elastic deformation, wherein the laser beam welds the metal sheets along the weld seam in a region of the contact zone.

15. The method as claimed in claim 14, wherein the curved metal sheets are manufactured from steel.

16. The method as claimed in claim 1, wherein the first workpiece and the second workpiece are in a form of flexible metal foils.

17. The method as claimed in claim 1, wherein the first workpiece and the second workpiece comprise electrical conductors and/or gas seals.

18. The method as claimed in claim 1, wherein the first workpiece and the second workpiece are bipolar plates of a fuel cell.
